(19) United States
(12) Patent Application Publication
(10) Pub. No.: US 2025/0085399 A1
(43) Pub. Date: Mar. 13, 2025

(54) UNDERWATER LASER COMMUNICATION OR SENSING SYSTEM AND METHOD

(71) Applicant: KYOCERA SLD Laser, Inc., Goleta, CA (US)

(72) Inventors: Sovan Das, Goleta, CA (US); Paul Rudy, Goleta, CA (US); Kathleen Hartnett, Goleta, CA (US)

(73) Assignee: KYOCERA SLD Laser, Inc., Goleta, CA (US)

(21) Appl. No.: 18/243,941

(22) Filed: Sep. 8, 2023

(51) Int. Cl. G01S 7/481; G01S 7/484; G01S 17/42; H04B 10/50; H04B 13/02

(52) U.S. Cl. CPC G01S 7/4815; G01S 7/484; G01S 17/42; H04B 10/503; H04B 13/02

(57) ABSTRACT

In an example, the present invention provides a system and method for underwater communications and sensing techniques using a gallium and nitride containing laser device configured to emit blue and/or green light. The techniques include LiDAR, LiFi, among others.

### BACKGROUND

Conventional techniques for underwater communication involve various methods and technologies to transmit information through water. Due to the unique properties of water, such as high absorption and scattering of electromagnetic signals, underwater communication poses significant challenges compared to communication in air. Certain conventional techniques along with their drawbacks are described below.

Acoustic communication has been the most widely used method for underwater communication due to its ability to propagate over long distances. Acoustic communication involves sending sound waves through the water to transmit data. However, there are several drawbacks. That is, acoustic signals have limited bandwidth, leading to lower data rates compared to electromagnetic communication. Sound waves travel at a much slower speed than electromagnetic waves, causing significant propagation delays, especially over long distances. Underwater environments are often noisy due to natural sounds, marine life, and human activities, leading to signal interference and reduced reliability. Acoustic signals can experience significant attenuation (loss of signal strength) over long distances, limiting the effective range of communication.

Another technique involves optical communications. That is, optical communication utilizes light signals, typically in the form of light emitting diodes, to transmit data through water. While it offers higher bandwidth compared to acoustics, it has its own drawbacks. Optical signals suffer from high scattering and absorption in water, limiting their effective range, especially in murky or turbid waters. Optical communication requires a direct line of sight between the transmitter and receiver, making it challenging in environments with obstacles or variable water conditions.

Yet another technique involves using low-frequency electromagnetic fields to induce currents in conductive underwater objects, such as pipelines or cables, for communication. Drawbacks include limited data rates, which are from induced currents that are relatively slow, leading to lower data rates compared to other methods. The technique also uses pre-existing conductive structures in the water, limiting its applicability in open ocean or remote areas.

From the above, it is seen that improved techniques for underwater communications are desirable.

### SUMMARY

The present invention relates to techniques, including methods and devices, for optical communication techniques configured for underwater applications. In particular, the present invention provides methods, devices, and systems using a gallium and nitrogen containing laser device configured to emit blue, violet, and/or green light for underwater communication and sensing techniques.

In an example, the present invention provides a system and method for underwater communications and sensing techniques using a gallium and nitride containing laser device configured to emit blue and/or green light. The techniques include LiDAR (Light Detection and Ranging), LiFi (Light Fidelity), among others.

In an example, the present invention provides a system for communication or sensing in a body of water. The system has an optical transmitter device that includes a laser diode device comprising a gallium and nitrogen containing material and configured to emit a laser beam. In an example, the laser diode device is capable of emitting light at a wavelength range of about 450 to 495 nm or 475 nm to 570 nm, the laser beam at a beam angle. The system has a beam steering optical element optically coupled to the laser beam emitted from the laser diode device and configured to steer the laser beam in the body of water to an object in the water. The beam steering optical element is capable of spatial movement based upon a response. In an example, the system has a laser driver device that is electrically coupled to the laser diode device. The laser driver device is coupled to a power source configured to supply power to the laser diode device, the laser drive device being configured to generate a drive signal with a modulation format. In an example, the system has a receiver device operably coupled to interact with the optical transmitter device. The receiver device has at least one photodiode device, which is configured to receive a scattered signal from an interaction from the laser beam with the object. In an example, the system has an electrical transmitter device coupled to the receiver device to transmit information related to the scattered signal.

In an alternative example, the present invention provides a system configured for communication or sensing in water. The system has a first transmitter device that includes at least one laser diode device comprised of gallium and nitrogen emitting a beam of light at a beam angle. The first transmitter device further includes a first optical element optically coupled to a light emitted from the laser diode device and is configured to steer the light to facilitate a spatial placement of the light to enable communication of information or sensing of objects in a body of water. The first optical element is capable of moving based upon a pre-determined programmed response to a beam angle. The system has a first receiver device that includes at least one photodiode device. In an example, the first receiver device is coupled to the first transmitter device. The system has a second transmitter device that includes at least one laser diode device comprised of gallium and nitrogen emitting a beam of light at a beam angle. The second transmitter device further includes a second optical element optically coupled to the light emitted from the laser diode device and is configured to steer the light to facilitate a spatial placement of the light to enable communication of information or sensing of objects in the body of water. The second optical element is capable of moving based upon a pre-determined programmed response to a beam angle. The system has a second receiver device that includes at least one photodiode device, the second receiver being coupled to the second transmitter device. The system has a spatial configuration between the first transmitter device and the first receiver device oriented to the second transmitter device and second receiver device to enable communication or sensing in the body of water.

In an alternative example, the invention provides a system for communication or sensing in a body of water. The system has an optical transmitter device that includes a laser diode device comprising a gallium and nitrogen containing material and configured to emit a laser beam. The laser diode device is capable of emitting light at a wavelength range of about 450 to 495 nm, the laser beam at a beam angle. In an example, the system has a beam steering optical element optically coupled to the laser beam emitted from the laser diode device and configured to steer the laser beam in the body of water to a target region in the body of water. The beam steering optical element is capable of spatial movement based upon a response. In an example the system has a laser driver device that is electrically coupled to the laser diode device. The laser driver device is coupled to a power source configured to supply power to the laser diode device. The laser driver device is configured to generate a first drive signal with a first modulation format. The first drive signal with the first modulation format is configured for a first signal rate. The system has a receiver device operably coupled to interact with the optical transmitter device; and which includes at least one photodiode device. The photodiode device is configured to receive a signal from the laser beam at the first signal rate to enable a connection between the receiver device and the transmitter device.

In an alternative example, the invention provides a system for communication or sensing in a body of water. The system has an optical transmitter device that includes a laser diode device comprising a gallium and nitrogen containing material and configured to emit a laser beam. The laser diode device is capable of emitting light at a wavelength range of about 450 to 495 nm at a beam angle. The system has a beam steering optical element optically coupled to the laser beam emitted from the laser diode device and configured to steer the laser beam in the body of water to a target region in the body of water. The beam steering optical element is capable of spatial movement based upon a response. In an example, the system has a detector device configured with the body of water to identify an optical characteristic of the body of water. The optical characteristic is defined by a Jerlov coefficient for an oceanic body of water or a coastal body of water. In an example, the system has a laser driver device that is electrically coupled to the laser diode device. The laser driver device is coupled to a power source configured to supply power to the laser diode device, the laser drive device being configured to generate a drive signal with a modulation format at a signal rate. In an example, the system has a feedback device coupled to the detector device and the laser drive device and is configured with the detector device to adapt the drive signal, modulation format, and the signal rate in response to the optical characteristic defined by the Jerlov coefficient. The system has a receiver device operably coupled to interact with the optical transmitter device and which includes at least one photodiode device. The photodiode device is configured to receive a signal from the laser beam at the signal rate to enable a connection between the receiver device and the transmitter device.

In an example, the present invention provides an alternative system for communication or sensing in a body of water. The system has an optical transmitter device that includes a laser diode device comprising a gallium and nitrogen containing material and configured to emit a laser beam. The system has a beam steering optical element optically coupled to the laser beam emitted from the laser diode device and configured to steer the laser beam in the body of water to a target region in the body of water. In an example, the system has a laser driver device that is electrically coupled to the laser diode device. The laser driver device is coupled to a power source configured to supply power to the laser diode device. The laser drive device is configured to generate a drive signal with a modulation format at a signal rate. The system has a receiver device operably coupled to interact with the optical transmitter device and which includes at least one photodiode device. The photodiode device is configured to receive a signal from the laser beam to enable a connection between the receiver device to the transmitter device. The system has a detector device configured with an output of the receiver device to detect a magnitude of a signal at the receiver device and a feedback device coupled to the detector device and the laser drive device. In an example, the feedback device is configured with the detector device to adapt the drive signal, modulation format, and the signal rate in response to the magnitude of the signal to achieve a predetermined signal to noise ratio.

Various benefits and/or advantages are offered by the present system and related methods. In an example, the invention includes use of a blue light, which has highest transparency through a body of water. Longer wavelengths and/or shorter wavelengths are absorbed more by water than blue light which is transmissive. In an example, blue lasers according to the present invention offer a preferred choice for a longest range because of a high degree of collimation and therefore the high intensity they can deliver at long distances. A high intensity beam delivery makes blue lasers the preferred choice for highest visibility illumination and highest signal to noise for sensing and communication. Additionally, blue lasers can be modulated at high speed for precision measurements and high-speed communications. According to the present invention, gallium and nitrogen containing laser diodes are preferred for blue laser technology because of their high efficiency, high reliability, and high output power, and their high speed modulation capability. These and other benefits and/or advantages are achievable with the present device and related methods. Further details of these benefits and/or advantages can be found throughout the present specification and more particularly below.

A further understanding of the nature and advantages of the invention may be realized by reference to the latter portions of the specification and attached drawings.

### BRIEF DESCRIPTION OF DRAWINGS

In order to more fully understand the present invention, reference is made to the accompanying drawings. Understanding that these drawings are not to be considered limitations in the scope of the invention, the presently described examples and the presently understood best mode of the invention are described with additional detail through use of the accompanying drawings in which:

FIG. 1 is a simplified diagram of an underwater communication system according to an example of the present invention.

FIG. 2 is a simplified diagram of an alternative underwater communication system according to an example of the present invention.

FIG. 3 is a simplified diagram of an alternative underwater communication system according to an example of the present invention.

FIG. 4 is a simplified diagram of a transmitter and receiving configuration according to an example of the present invention.

FIG. 5 is a simplified diagram of an alternative transmitter and receiving configuration according to an example of the present invention.

FIG. 6 is a simplified diagram of an alternative transmitter and receiving configuration according to an example of the present invention.

FIG. 7 is a simplified diagram of a beam steering system for underwater communications according to an example of the present invention.

FIG. 8 is a simplified diagram of a more detailed beam steering system for underwater communications according to an example of the present invention.

FIG. 9 is a plot of low frequency alignment and high frequency data communications for underwater communications according to an example of the present invention.

FIG. 10 is a simplified diagram of LiFi underwater communications according to an example of the present invention.

FIGS. 11 and 12 are simplified block diagrams of underwater communication systems according to examples of the present invention.

### DETAILED DESCRIPTION OF EXAMPLES

In an example, the present invention provides a system for underwater communication. In particular, the present invention uses a gallium and nitrogen containing laser diode device configured to emit blue light for communication and/or sensing techniques. In an example, such techniques can include LiFi (Light Fidelity), LiDAR (Light Detection and Ranging), and others.

In an example, underwater LiFi, also known as underwater visible light communication (UVLC), enables high-speed data communication underwater using visible light as the communication medium. LiFi stands for “Light Fidelity,” and it is a wireless communication technology that utilizes light waves to transmit data. Unlike traditional radio frequency-based communication technologies like WiFi, which struggle to transmit signals through water due to its high absorption and scattering properties, underwater LiFi takes advantage of the unique properties of visible light to enable communication in aquatic environments.

In an example, underwater LiFi utilizes laser light signals that are modulated rapidly. These light sources are often equipped with specialized hardware to modulate the light at extremely high speeds, typically in the order of hundreds of megabits or even gigabits per second. In an example, data to be transmitted is encoded onto the intensity variations of the light source. These variations are imperceptible to the human eye but can be accurately detected and decoded by light-sensitive receivers. In an example, underwater LiFi systems include light-sensitive photodetectors or photodiodes that are capable of capturing the variations in light intensity. These receivers then convert the detected light variations back into digital data. Once the light variations are captured by the receivers, the received signal goes through signal processing techniques to extract the encoded data. Error correction and data integrity measures are often applied to ensure reliable communication, especially in challenging underwater environments where signal quality can be compromised by factors like water turbidity and movement.

According to the present invention, underwater LiFi has various applications, including but not limited to, underwater communication between autonomous underwater vehicles (AUVs), underwater sensors, research equipment, and even for enhancing communication capabilities between scuba divers. In an example, underwater LiFi can be particularly useful in scenarios where traditional RF-based communication is limited due to water's attenuating effects on radio waves.

In an example, underwater LiDAR (Light Detection and Ranging) uses laser pulses to measure distances and create detailed 3D maps of underwater environments. Similar to its airborne counterpart used on land, underwater LiDAR employs laser beams to measure the time it takes for light to travel to an object and back, allowing for accurate distance calculations and the generation of high-resolution underwater topographical data.

In an example, a laser device emitter is positioned on a submerged platform such as a boat, underwater vehicle, or a stationary installation. This emitter sends out short pulses of laser light into the water. The emitted laser pulses travel through the water until they encounter an object, the seafloor, or any other underwater feature. When the light hits an object, some of it gets scattered, and a portion is reflected back towards the LiDAR system.

In an example, the LiDAR system measures the time it takes for the laser light to travel from the emitter to the object and back to the receiver. Since the speed of light in water is constant, this time can be used to calculate the distance between the LiDAR system and the object with high precision. By emitting numerous laser pulses and recording the time-of-flight for each pulse, the LiDAR system collects a large amount of distance measurements. These measurements are combined to create a point cloud, which is a three-dimensional representation of the underwater environment's surface.

In an example, point cloud data is then processed using methods to create detailed underwater maps. These maps can reveal underwater terrain, structures, vegetation, and even submerged objects. The collected data can also be used to assess water quality, monitor changes in the underwater landscape, and support various scientific and industrial applications.

According to the present invention, underwater LiDAR has numerous applications, including marine research, underwater archaeology, hydrographic surveys, environmental monitoring, underwater construction, pipeline inspection, and habitat mapping. In an example, underwater LiDAR provides insights into underwater ecosystems, assist in locating underwater artifacts and geological features, and aid in infrastructure planning and maintenance. In an example, underwater LiDAR technology contributes to our understanding of the submerged world by offering a non-invasive and precise method for mapping and studying underwater environments in detail.

Further details of the present techniques can be found more fully in the figures and descriptions below.

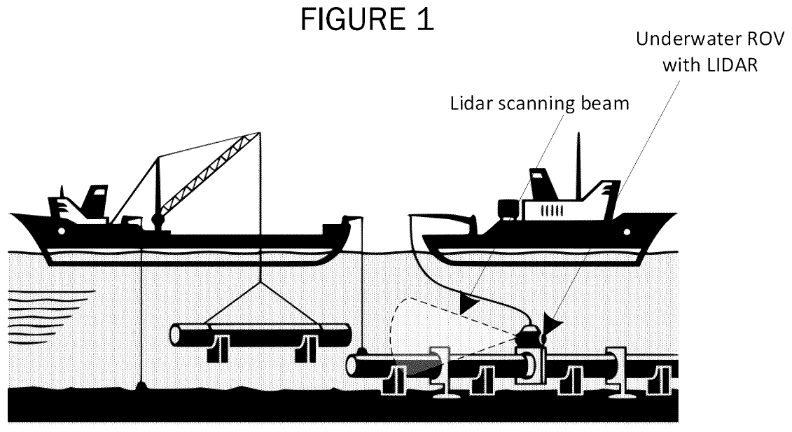

FIG. 1 is a simplified diagram of an underwater communication system according to an example of the present invention. As shown, the diagram has a body of water, and water vessels, e.g., boats. One of the boats is laying underwater pipeline and the second boat is surveying the construction using an underwater remotely operated vehicle (ROV) which is communicating with the surveillance boat over tethered communication. The ROV is capturing three dimensional images of the construction using the underwater LiDAR and transmitting it to the boat over the wire as the images require high speed communication link. The wired communication facilitates the high-speed communication but restricts the motion and orientation of the ROV, which makes the surveillance a time consuming, expensive and tedious task.

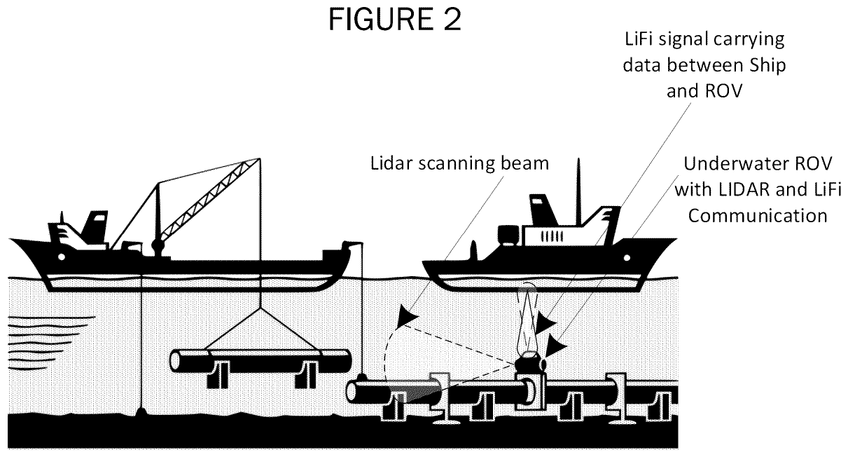

FIG. 2 is a simplified diagram of an alternative underwater communication system according to an example of the present invention. As shown, the diagram has a body of water, and water vessels, e.g., boats. One of the boats is coupled to an underwater communication system, including a LiDAR scanning beam and LiFi. In this figure, the surveillance boat is using LiFi to communicate with the surveillance boat instead of the wire communication as depicted in FIG. 1. This eliminates the motion and orientation restrictions on the ROV while supporting high-speed communication. The three-dimensional images of the construction site are being fed at very low latency with highest resolution possible.

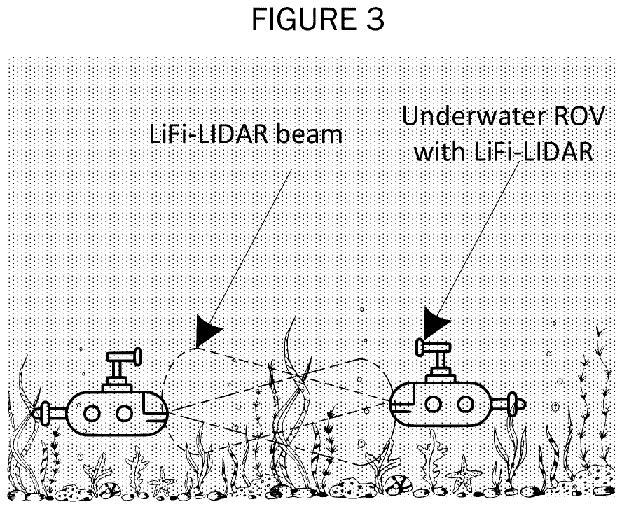

FIG. 3 is a simplified diagram of an alternative underwater communication system according to an example of the present invention. As shown, the diagram has a body of water, and water vessels, e.g., remotely operated vehicle. The ROVs are coupled to an underwater communication system, including a LiDAR scanning beam and LiFi. In an example, the LiDAR-LiFi system can simultaneously perform sensing and communication. The two ROVs can communicate with each other through the LiFi link while using the same beam transmitted beam's reflection to capture the three-dimensional image of the objects within the field of view of the transmitter. In this case the submarines are able to map the aquatic plants and other particulates floating in the water body. The captured 3-D images could be exchanged between ROVs to create a point cloud of the aquatic environment.

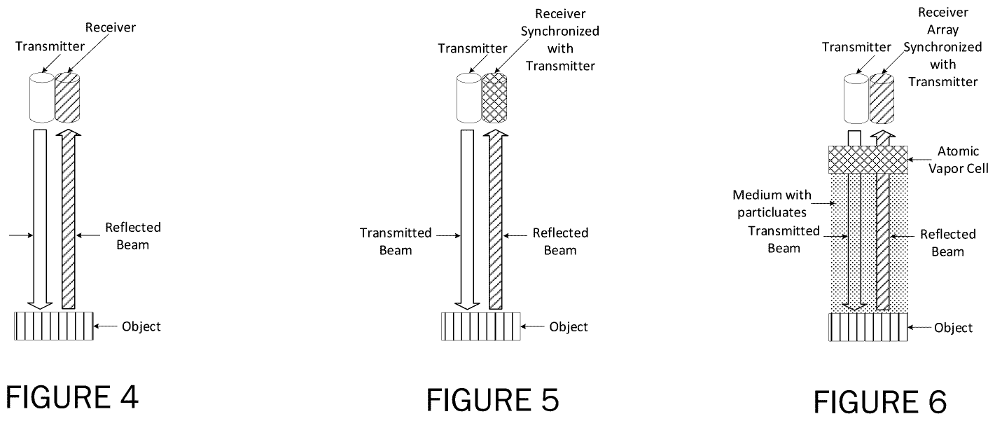

FIG. 4 is a simplified diagram of a transmitter and receiving configuration according to an example of the present invention. As shown, the diagram includes a transmitter device and a receiving device operably coupled to an object. In an example, the receiver captures the reflected beam from a blue laser diode light source from the object. Such a setup with the blue laser diode device and corresponding receiver is used underwater as a proximity sensor, i.e. to sense the presence of objects and avoid collisions or help ROVs to dock on to the different structures. The intensity of the reflected light is higher if the object is closer and the intensity is lower if the object is further.

FIG. 5 is a simplified diagram of an alternative transmitter and receiving configuration according to an example of the present invention. As shown, the diagram includes a transmitter device and a receiving device operably coupled to an object. The transmitter device is synchronized with the receiving device. The transmitter generates pulses and the receiver captures the reflected pulsed beam. As the transmission and reception are synchronized. The time delay or phase shift between the transmitted pulse and the received pulse could be calculated to measure the distance of the object. This type of time of light measurement is defined as indirect time of flight measurement. This is technique is highly ineffective in terrestrial application as it difficult to measure the phase difference in well-lit environment. Underwater there are no or limited light sources which works in favor of this technique. Furthermore, currently there are only underwater acoustic time of flight sensors. The main disadvantage of acoustic sensors is that they cannot generate very high pulses and are typically to ultrasonic pulses (20 kHz to 100 kHz) which limits the accuracy of the measurement. Furthermore, the higher the frequency of the acoustic sensor, the shorter is the measurement range. On the contrary, with our blue laser-based time of flight sensor, the laser could be modulated in order of MHz to GHz which significantly boosts the measurement accuracy and the modulation pulse width doesn't affect the measurement range. The measurement range is dependent on the intensity of laser, water body type, optical elements collimating the laser and the receiver technology. Measurement of laser pulse phase shift or time delay is immune to irradiance fluctuations caused by the water current or temperature gradient. Although, particulates in the water with size comparable to wavelength of the laser beam introduces measurement error as these particles can introduce scattering and limit the measurement range.

FIG. 6 is a simplified diagram of an alternative transmitter and receiving configuration according to an example of the present invention. As shown, the diagram includes a transmitter device and a receiving device operably coupled to an object. The transmitter device is synchronized with the receiving device. An atomic vapor cell is also shown.

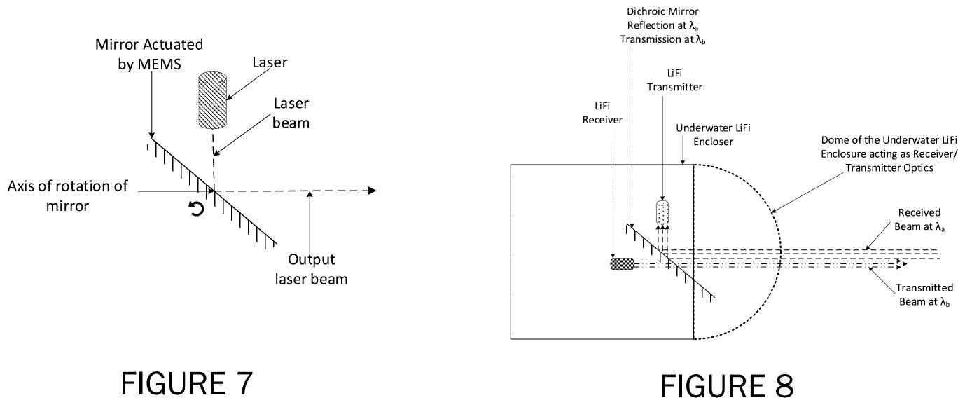

FIG. 7 is a simplified diagram of a beam steering system for underwater communications according to an example of the present invention. As shown, the system has a laser device operably coupled to a mirror for beam steering. As shown, the figure depicts the top-view of the system. The mirror is actuated by micro-electromechanical systems to control the beam propagation direction. The maximum field of view that can achieved with this technique is 180 degrees in an example. In an example, the mirror can freely rotate about an axis or oscillate between a set angle about the axis to emit the laser beam in a scanning fashion. This enables improving the field of view of the underwater LiDAR system, without sacrificing the beam intensity as the beam divergence of the laser could be limited to order of micro radians.

In an example, beam steering mirrors are optical components designed to manipulate the direction of laser beams by reflecting them at various angles. In an example, types of beam steering mirrors including flat mirrors. In an example, a flat mirror has a flat, reflective surface, typically coated with a highly reflective material like aluminum or silver. In an example, the flat mirror is used for basic beam redirection, such as changing the laser beam's direction by 90 degrees or for folding the beam path. In an example, the mirror can have various sizes and coatings to suit different laser wavelengths. In an alternative example, the beam steering occurs using gimbal mirrors. The gimbal mirror is mounted on gimbals or two-axis tilt stages. This allows for precise control over the angle at which the laser beam is steered. Other mirrors include galvanometer scanners, acousto-optic (AO) beam deflectors, among others.

In an example, the beam steering is selected from one of six different spatial orientations. In an example, the beam steering changes a spatial orientation of a beam angle in reference to a direction of the laser beam. In an example, the movable beam steering optical element is configured to direct, collimate, focus, or otherwise modify the angle of the light emitted from the first laser diode device. The beam steering optical element includes a micromechanical system (MEMS) scanning mirror, a flying mirror, a digital light processing (DLP) chip, a digital mirror device (DMD), or a liquid crystal on silicon (LCOS) chip. In an example, the beam steering optical element comprises one or a combination of optical elements selected a list of slow axis collimating lens, fast axis collimating lens, aspheric lens, ball lens, total internal reflector (TIR) optics, parabolic lens optics, refractive optics, and micro-electromechanical system (MEMS) mirrors configured to direct, collimate, focus a light to at least modify an angular distribution thereof. In an example, the beam steering optical element is selected from one of a micro-electromechanical system (MEMS) mirror, a digital light processing (DLP) chip, a digital mirror device (DMD), and a liquid crystal on silicon (LCOS) chip for steering, patterning, or pixelating. In an example, the beam steering optical element is a MEMS mirror and is based on actuators that are electromagnetic, electrostatic, piezoelectric, electrothermal, pneumatic, or shape memory alloy.

FIG. 8 is a simplified diagram of a more detailed optical system for underwater communications according to an example of the present invention. The illustration is a top view section of the system. As shown, the system has a laser device operably coupled to a dichroic mirror which reflects some wavelengths and allows some wavelengths to transmit through it. Therefore, the receiver wavelength and the transmitter wavelength are different. By using the dichroic mirror, the transmit and receive optical signal are coaxial. If the transmitted and received beam are nonconcentric then the uplink and downlink of the two communicating devices needs to be aligned independently. This would require two alignment systems on each side, one for transmitter and one for receiver. Therefore, coaxial transmit and receive beam avoids the need of aligning the transmit and receive beam independently on both sides of the LiFi system, requiring only one alignment system on each side. This ultimately simplifies the alignment system and helps achieve stable optical links over long distances. The system has a transmitter device and a receiving device configured within a sealed housing, which includes an aperture window, as shown. The aperture is in the shape of dome which acts as an optical element to collimate the received signal beam onto the photodiode's active area and set the right divergence angle for the transmit beam.

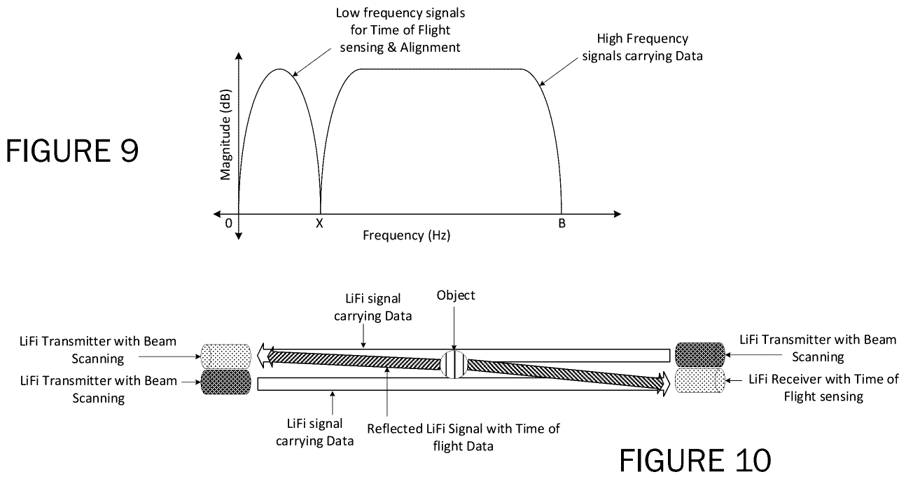

FIG. 9 is a plot of low frequency alignment and high frequency data communications, transmitted by the laser device, for underwater communications according to an example of the present invention. As shown, the plot represents magnitude on a vertical axis, and frequency on a horizontal axis. As shown, a lower frequency is configured with a time of flight sensor to align an optical communication signal, and once aligned and connected, data is transferred at a higher frequency rate for efficiency. Furthermore, the lower frequency pulses would be used for time of flight sensing.

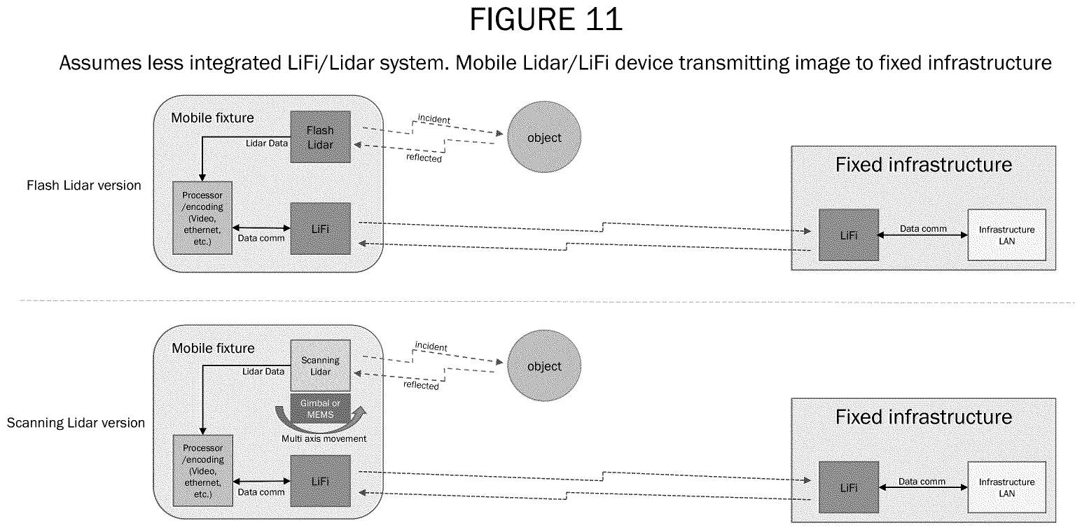

FIG. 10 is a simplified diagram of LiFi underwater communications according to an example of the present invention. As shown, each of the LiFi transmitters is configured to emit an electromagnetic beam having a different pulse width so that the transmitters do not interfere with each other. In an example, the system is configured to combine LiDAR and LiFi into a single integrated system to allow for localization and imaging from LiDAR. In an example, the system includes a laser diode device configured to emit electromagnetic radiation. The laser diode device is coupled to a detector, which is a photodetector, and coupled to a digital signal processing system. The digital signal processing system is coupled to a computer processing unit or microcontroller device.

As shown, in an example, LiFi transmitters each of which has beam steering is configured with a different pulse width operating on different optical wavelength for LiDAR to distinguish between each of the transmitted LiDAR signals.

In an example, the LiFi transmitters can also be non-scanning. In an example, a LiFi receiver with time of flight sensor is coupled with an imaging sensor to generate a two-dimensional image of an object. The time-of-flight data is obtained from the LiFi receiver. In an example, a first LiFi transmitter is configured to generate a point cloud of the object by the time-of-flight data and the two-dimensional image. Similarly, a second LiFi transmitter is also configured to generate a point cloud of object C. Each pair of LiFi transmitters establishes a optical communication link. In an example, the point clouds acquired by the transmitters can be exchanged between each other, over the optical link, to combine and create a three-dimensional point cloud of the object in real time.

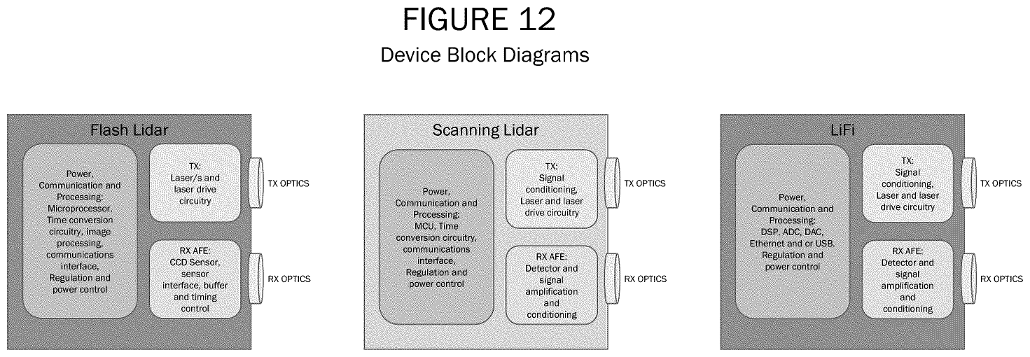

FIG. 12 is a simplified block diagram of underwater communication and LiDAR systems according to examples of the present invention. In an example, the analog front-ends of underwater flash LiDAR, Scanning LiDAR and LiFi are similar, except that the scanning LiDAR uses a moving mirror to steer the beam in different directions to perform the scanning function. A motion of the mirror sets the field of view in Scanning LiDAR. In flash LiDAR the transmitter optics sets the field of view. The digital signal processing behind each of the system are different from each other. The digital signal processing for a LiFi system converts the user data from digital data transmitted over wire to a format that can be encoded over the intensity of a laser and decode that back. In LiDAR, the digital signal processing platform generates high speed pulses and measure the time delay between the transmitted and received pulse to calculate the distance of the target. Furthermore, when there is a receiver array the processor would convert the array of the received measurements to a two-dimensional image with depth information.

In an example, the present system provides a beam angle that can be focused manipulated spatially for facilitating sensing or communicating. In an example, the system is configured to overcome attenuations caused by an ocean or body of water with turbidity, thermal gradients, currents, waves, turbulence, and particulates, e.g., organic and/or inorganic. In an example, the particulates can include pollutants, debris, micro particles, and other features. In an example, such attenuations can also be sensed or detected to detect hazards, e.g., leaks.

In an example, the present invention provides a system for communication or sensing in a body of water. The system has an optical transmitter device that includes a laser diode device comprising a gallium and nitrogen containing material and configured to emit a laser beam. In an example, the laser diode device is capable of emitting light at a wavelength range of about 450 to 495 nm or 475 nm to 570 nm, the laser beam at a beam angle. The system has a beam steering optical element optically coupled to the laser beam emitted from the laser diode device and configured to steer the laser beam in the body of water to an object in the water. The beam steering optical element is capable of spatial movement based upon a response. In an example, the system has a laser driver device that is electrically coupled to the laser diode device. The laser driver device is coupled to a power source configured to supply power to the laser diode device, the laser drive device being configured to generate a drive signal with a modulation format. In an example, the system has a receiver device operably coupled to interact with the optical transmitter device. The receiver device has at least one photodiode device, which is configured to receive a scattered signal from an interaction from the laser beam with the object. In an example, the system has an electrical transmitter device coupled to the receiver device to transmit information related to the scattered signal.

In an example, the beam steering is selected from one of six different spatial orientations. In an example, the beam steering changes a spatial orientation of a beam angle in reference to a direction of the laser beam. In an example, the movable beam steering optical element is configured to direct, collimate, focus, or otherwise modify the angle of the light emitted from the first laser diode device. The beam steering optical element includes a micromechanical system (MEMS) scanning mirror, a flying mirror, a digital light processing (DLP) chip, a digital mirror device (DMD), or a liquid crystal on silicon (LCOS) chip. In an example, the beam steering optical element comprises one or a combination of optical elements selected a list of slow axis collimating lens, fast axis collimating lens, aspheric lens, ball lens, total internal reflector (TIR) optics, parabolic lens optics, refractive optics, and micro-electromechanical system (MEMS) mirrors configured to direct, collimate, focus a light to at least modify an angular distribution thereof. In an example, the beam steering optical element is selected from one of a micro-electromechanical system (MEMS) mirror, a digital light processing (DLP) chip, a digital mirror device (DMD), and a liquid crystal on silicon (LCOS) chip for steering, patterning, or pixelating. In an example, the beam steering optical element is a MEMS mirror and is based on actuators that are electromagnetic, electrostatic, piezoelectric, electrothermal, pneumatic, or shape memory alloy.

The electrical transmitter device transmits the information to a remote receiver coupled to a processor device in an example. The processor device is configured to perform an analysis on the scattered signal.

In an example, the system further has a waveguide coupled to the movable beam steering optical element.

In an example, the laser driver device includes the drive signal having a data signal or sensing signal that comprises the modulation according to a pre-selected data modulation rate. In an example, the modulation format is characterized by a modulation rate to achieve a signal to noise ratio of 10:1 through the body of water.

In an example, the laser device has various characteristics. That is, the laser device comprises two or more laser diode devices. Each of the laser diode devices comprises a gallium and nitrogen containing material and configured as a laser beam. In an example, at least one of the laser diode devices capable of emitting light at a wavelength range of about 500 to 570 nm and configured at a beam angle, where the beam angle may be the same as or different from the beam angle of the other laser diode device. In an example, the laser beam is collimated. In an example, the laser beam is capable of being transmitted through the body of water at a distance of 1 to 1000 meters, and the scattered signal from the object to the receiver device has a distance ranging up to 1000 meters.

In an example, the transmitter device and the receiver device are located on a substrate device.

In an example, the body of water is characterized by at least one of turbidity, water currents, turbulent flow, laminar flow, thermal gradients, or air pockets. In an example, the object is at least one of a natural object, an artificial object, a biological particle, a gas or an oil, a hazard, a solid surface, or a porous surface.

In an example, the system is configured for LiDAR, LiFi, Flash LiDAR, or Scanning LiDAR, among others.

In an example, the system has a time-of-flight device coupled to the receiver device.

In an example, the gallium and nitrogen containing material comprises one or more of GaN, AlN, InN, InGaN, AlGaN, InAlN, InAlGaN, among others. In an example, the laser diode device comprises a ridge laser.

The laser beam is a laser pulse modulated with a rate in a range selected from 50 MHz to 300 MHz, 300 MHz to 1 GHz, or 1 GHz to 100 GHz based on the modulation format.

The system has an optical pathway comprises optics selected from free-space optics, waveguide, and optical fiber configured to guide, filter, collimate, focus, combine, and split the laser light.

In an example, the modulation format comprises one selected from double-sideband modulation (DSB), double-sideband modulation with carrier (DSB-WC), double-sideband suppressed-carrier transmission (DSB-SC), double-sideband reduced carrier transmission (DSB-RC), single-sideband modulation (SSB, or SSB-AM), single-sideband modulation with carrier (SSB-WC), single-sideband modulation suppressed carrier modulation (SSB-SC), vestigial sideband modulation (VSB, or VSB-AM), quadrature amplitude modulation (QAM), pulse amplitude modulation (PAM), phase-shift keying (PSK), frequency-shift keying (FSK), continuous phase modulation (CPM), minimum-shift keying (MSK), Gaussian minimum-shift keying (GMSK), continuous-phase frequency-shift keying (CPFSK), orthogonal frequency-division multiplexing (OFDM), or discrete multitone (DMT).

To prevent water damage, the system preferably has a housing for enclosing the system to be sealed from the body of water to maintain the optical transmitter device free from water damage.

In an example, the system further has an atomic vapor cell device operably coupled to the receiver device and/or transmitter device.

In an example, the present invention provides a system configured for communication or sensing in water. The system has a first transmitter device that includes at least one laser diode device comprised of gallium and nitrogen emitting a beam of light at a beam angle. The first transmitter device further includes a first optical element optically coupled to a light emitted from the laser diode device and is configured to steer the light to facilitate a spatial placement of the light to enable communication of information or sensing of objects in a body of water. The first optical element is capable of moving based upon a pre-determined programmed response to a beam angle. The system has a first receiver device that includes at least one photodiode device. In an example, the first receiver device is coupled to the first transmitter device. The system has a second transmitter device that includes at least one laser diode device comprised of gallium and nitrogen emitting a beam of light at a beam angle. The second transmitter device further includes a second optical element optically coupled to the light emitted from the laser diode device and is configured to steer the light to facilitate a spatial placement of the light to enable communication of information or sensing of objects in the body of water. The second optical element is capable of moving based upon a pre-determined programmed response to a beam angle. The system has a second receiver device that includes at least one photodiode device, the second receiver being coupled to the second transmitter device. The system has a spatial configuration between the first transmitter device and the first receiver device oriented to the second transmitter device and second receiver device to enable communication or sensing in the body of water.

In an example, the invention provides a system for communication or sensing in a body of water. The system has an optical transmitter device that includes a laser diode device comprising a gallium and nitrogen containing material and configured to emit a laser beam. The laser diode device is capable of emitting light at a wavelength range of about 450 to 495 nm, the laser beam at a beam angle. In an example, the system has a beam steering optical element optically coupled to the laser beam emitted from the laser diode device and configured to steer the laser beam in the body of water to a target region in the body of water. The beam steering optical element is capable of spatial movement based upon a response. In an example the system has a laser driver device that is electrically coupled to the laser diode device. The laser driver device is coupled to a power source configured to supply power to the laser diode device. The laser driver device is configured to generate a first drive signal with a first modulation format. The first drive signal with the first modulation format is configured for a first signal rate. The system has a receiver device operably coupled to interact with the optical transmitter device; and which includes at least one photodiode device. The photodiode device configured to receive a signal from the laser beam at the first signal rate to enable a connection between the receiver device to the transmitter device.

In an example, the laser driver device is configured to generate a second drive signal with a second modulation format. The second drive signal with the second modulation format is configured for a second signal rate. The second signal rate is faster than the first signal rate by at least 100% to enable transfer of data from a storage device coupled to the optical transmitter device to the receiver device. In an example the laser driver device comprises a first laser driver device and a second laser driver device. In an example, the laser diode device comprises a first laser diode device and a second laser diode device. The first laser driver device is coupled to the first laser diode device for the first drive signal and the second laser driver device is coupled to the second laser diode device for the second drive signal.

In an example, the modulation format is characterized by a modulation rate to achieve a signal to noise ratio of 10:1 through the body of water. In an example, the laser beam is capable of being transmitted through the body of water at a distance of 1 to 1000 meters, and the scattered signal from the object to the receiver device has a distance ranging up to 1000 meters.

In an example, the body of water is characterized by at least one of turbidity, water currents, turbulent flow, laminar flow, thermal gradients, or air pockets. In an example, the object is at least one of a natural object, an artificial object, a biological particle, a gas or an oil, a hazard, a solid surface, or a porous surface.

In an alternative example, the invention provides a system for communication or sensing in a body of water. The system has an optical transmitter device that includes a laser diode device comprising a gallium and nitrogen containing material and configured to emit a laser beam. The laser diode device is capable of emitting light at a wavelength range of about 450 to 495 nm at a beam angle. The system has a beam steering optical element optically coupled to the laser beam emitted from the laser diode device and configured to steer the laser beam in the body of water to a target region in the body of water. The beam steering optical element capable of spatial movement based upon a response. In an example, the system has a detector device configured with the body of water to identify an optical characteristic of the body of water. The optical characteristic is defined by a Jerlov coefficient for an oceanic body of water or a coastal body of water. In an example, the system has a laser driver device that is electrically coupled to the laser diode device. The laser driver device is coupled to a power source configured to supply power to the laser diode device. The laser drive device being configured to generate a drive signal with a modulation format at a signal rate. In an example, the system has a feedback device coupled to the detector device and the laser drive device and is configured with the detector device to adapt the drive signal, modulation format, and the signal rate in response to the optical characteristic defined by the Jerlov coefficient. The system has a receiver device operably coupled to interact with the optical transmitter device and which includes at least one photodiode device. The photodiode device is configured to receive a signal from the laser beam at the signal rate to enable a connection between the receiver device to the transmitter device.

In an example, the Jerlov coefficient is selected from Type I, II, or III. In an example, the Jerlov coefficient is selected from category 1, 2, 3, 4, 5, 6, 7, 8, and 9.

In an example, the Jerlov coefficients, often referred to as Jerlov water types or Jerlov classes, are a set of parameters used to describe the optical properties of natural waters, particularly in terms of how they affect the penetration of light through the water column. These coefficients have been named after the Danish oceanographer Niels Gunnar Jerlov, who developed them in the mid-20th century. They are important in various fields of science and engineering, including oceanography, remote sensing, and underwater optics.

There are five Jerlov water types, each characterized by different optical properties:

### Jerlov Type I: Extremely Clear Oceanic Waters

These waters have very low concentrations of particles and dissolved materials, resulting in excellent light penetration. The Jerlov Type I waters are often found in open ocean regions far from coastlines.

### Jerlov Type II: Coastal or Turbid Oceanic Waters

These waters have somewhat reduced clarity compared to Type I, due to slightly higher concentrations of particles and dissolved substances. Coastal areas, where river runoff and sediment input are common, often fall into this category.

### Jerlov Type III: Coastal or Turbid Waters with High Sediment Load

Jerlov Type III waters have even lower clarity than Type II, mainly due to a high concentration of suspended particles and sediments. Estuaries, river deltas, and areas affected by heavy human activities often exhibit Type III characteristics.

### Jerlov Type IV: Green Waters

These waters are characterized by high concentrations of phytoplankton or other organic material, which give them a greenish hue. Coastal regions with significant algal blooms or nutrient runoff can display Jerlov Type IV properties.

### Jerlov Type V: Coastal or Inland Waters Rich in Humic Substances

Jerlov Type V waters contain a significant amount of dissolved organic material, such as humic acids. This dissolved material can reduce light penetration and give the water a brownish tint. Many inland water bodies, like lakes and rivers, exhibit Type V characteristics, especially in areas with abundant organic inputs.

Understanding Jerlov water types is desirable for various applications, such as designing underwater optical systems, predicting light penetration in the ocean, and interpreting remote sensing data. Different water types require different approaches when it comes to studying or working in aquatic environments, as the optical properties impact the availability of light for photosynthesis, remote sensing, and other ecological and scientific processes.

In an example, the present invention provides an alternative system for communication or sensing in a body of water. The system has an optical transmitter device that includes a laser diode device comprising a gallium and nitrogen containing material and configured to emit a laser beam. The system has a beam steering optical element optically coupled to the laser beam emitted from the laser diode device and configured to steer the laser beam in the body of water to a target region in the body of water. In an example, the system has a laser driver device that is electrically coupled to the laser diode device. The laser driver device is coupled to a power source configured to supply power to the laser diode device. The laser drive device is configured to generate a drive signal with a modulation format at a signal rate. The system has a receiver device operably coupled to interact with the optical transmitter device and which includes at least one photodiode device. The photodiode device is configured to receive a signal from the laser beam to enable a connection between the receiver device to the transmitter device. The system has a detector device configured with an output of the receiver device to detect a magnitude of a signal at the receiver device and a feedback device coupled to the detector device and the laser drive device. In an example, the feedback device is configured with the detector device to adapt the drive signal, modulation format, and the signal rate in response to the magnitude of the signal to achieve a predetermined signal to noise ratio.

In an example, the present invention includes an optical element (e.g., lens, transparent member) coupled to an output of the laser device and configured to seal the output from the body of water, and configured to emit the laser beam through the optical element into the body of water. In an example, the optical element is planar and configured normal to a direction of the laser beam. In an example, the optical element is curved and is configured to focus the laser beam. In an example, the optical element has a coating overlying a surface of the optical element.

In an example, the laser diode device comprises a plurality of laser diode devices, each of the laser diode devices being configured to emit a wavelength of a narrow wavelength range, the narrow wavelength range being at a desired wavelength with a variation of three nanometers.

As used herein, the term GaN substrate is associated with Group III-nitride based materials including GaN, InGaN, AlGaN, or other Group III containing alloys or compositions that are used as starting materials. Such starting materials include polar GaN substrates (i.e., substrate where the largest area surface is nominally an (h k l) plane wherein h=k=0, and l is non-zero), non-polar GaN substrates (i.e., substrate material where the largest area surface is oriented at an angle ranging from about 80-100 degrees from the polar orientation described above towards an (h k l) plane wherein l=0, and at least one of h and k is non-zero) or semi-polar GaN substrates (i.e., substrate material where the largest area surface is oriented at an angle ranging from about +0.1 to 80 degrees or 110-179.9 degrees from the polar orientation described above towards an (h k l) plane wherein l=0, and at least one of h and k is non-zero).

References, each of which is commonly assigned, and hereby incorporated by reference for all purposes: U.S. Pat. Nos. 10,873,395; 10,784,960; 10,880,005; 10,784,960; and 11,277,204.

While the above is a full description of the specific examples, various modifications, alternative constructions and equivalents may be used. In an example, the terms first, second, third, and final do not imply order in one or more of the present examples. Therefore, the above description and illustrations should not be taken as limiting the scope of the present invention which is defined by the appended claims.

1. A system for communication or sensing in a body of water, the system comprising:
an optical transmitter device that includes a laser diode device comprising a gallium and nitrogen containing material and configured to emit a laser beam, the laser diode device capable of emitting light at a wavelength range of about 450 to 495 nm or 475 nm to 570 nm, the laser beam at a beam angle;
a beam steering optical element optically coupled to the laser beam emitted from the laser diode device and configured to steer the laser beam in the body of water to an object in the water, the beam steering optical element capable of spatial movement based upon a response;
a laser driver device that is electrically coupled to the laser diode device, the laser driver device coupled to a power source configured to supply power to the laser diode device, the laser drive device being configured to generate a drive signal with a modulation format;
a receiver device operably coupled to interact with the optical transmitter device and which includes at least one photodiode device, the photodiode device configured to receive a scattered signal from an interaction from the laser beam with the object; and
an electrical transmitter device coupled to the receiver device to transmit information related to the scattered signal.

2. The system of claim 1 wherein the beam steering is selected from one of six different spatial orientations.

3. The system of claim 1 wherein the beam steering changes a spatial orientation of a beam angle in reference to a direction of the laser beam.

4. The system of claim 1 wherein the electrical transmitter device transmits the information to a remote receiver coupled to a processor device, the processor device configured to perform an analysis on the scattered signal.

5. The system of claim 1 further comprising a waveguide coupled to the beam steering optical element.

6. The system of claim 1 wherein the laser driver device includes the drive signal having a data signal or sensing signal that comprises the modulation according to a pre-selected data modulation rate.

7. The system claim 1 wherein the beam steering optical element is configured to direct, collimate, focus or otherwise modify the angle of the light emitted from the laser diode device.

8. The system of claim 1 wherein the beam steering optical element includes a micromechanical system (MEMS) scanning mirror, a flying mirror, a digital light processing (DLP) chip, a digital mirror device (DMD), or a liquid crystal on silicon (LCOS) chip.

9. The system of claim 1 wherein the laser diode device comprises two or more laser diode devices, each of the laser diode devices comprising a gallium and nitrogen containing material and configured as a laser beam, at least one of the laser diode devices capable of emitting light at a wavelength range of about 500 to 570 nm and configured at a beam angle, wherein the beam angle may be the same as or different from the beam angle of the other laser diode device.

10. The system of claim 1 wherein the laser beam is collimated.

11. The system of claim 1 wherein the modulation format is characterized by a modulation rate to achieve a signal to noise ratio of 10:1 through the body of water.

12. The system of claim 1 wherein the laser beam is capable of being transmitted through the body of water at a distance of 1 to 1000 meters, and the scattered signal from the object to the receiver device has a distance ranging up to 1000 meters.

13. The system of claim 1 wherein the transmitter device and the receiver device are located on a substrate device.

14.-15. (canceled)

16. The system of claim 1 wherein the system is configured for LiDAR, LiFi, Flash LiDAR, or Scanning LiDAR.

17. The system of claim 1 further comprising a time-of-flight device coupled to the receiver device.

18. The system of claim 1 wherein the gallium and nitrogen containing material comprises one or more of GaN, AlN, InN, InGaN, AlGaN, InAlN, InAlGaN.

19. The system of claim 1 wherein the laser beam is a laser pulse modulated with a rate in a range selected from 50 MHz to 300 MHz, 300 MHz to 1 GHz, or 1 GHz to 100 GHz based on the modulation format.

20. (canceled)

21. The system of claim 1 wherein the beam steering optical element comprises one or a combination of optical elements selected a list of slow axis collimating lens, fast axis collimating lens, aspheric lens, ball lens, total internal reflector (TIR) optics, parabolic lens optics, refractive optics, and micro-electromechanical system (MEMS) mirrors configured to direct, collimate, focus a light to at least modify an angular distribution thereof.

22. (canceled)

23. The system of claim 1 wherein the beam steering optical element is a MEMS mirror and is based on actuators that are electromagnetic, electrostatic, piezoelectric, electrothermal, pneumatic, or shape memory alloy.

24. The system of claim 1 wherein the modulation format comprises one selected from double-sideband modulation (DSB), double-sideband modulation with carrier (DSB-WC), double-sideband suppressed-carrier transmission (DSB-SC), double-sideband reduced carrier transmission (DSB-RC), single-sideband modulation (SSB, or SSB-AM), single-sideband modulation with carrier (SSB-WC), single-sideband modulation suppressed carrier modulation (SSB-SC), vestigial sideband modulation (VSB, or VSB-AM), quadrature amplitude modulation (QAM), pulse amplitude modulation (PAM), phase-shift keying (PSK), frequency-shift keying (FSK), continuous phase modulation (CPM), minimum-shift keying (MSK), Gaussian minimum-shift keying (GMSK), continuous-phase frequency-shift keying (CPFSK), orthogonal frequency-division multiplexing (OFDM), or discrete multitone (DMT).

25.-98. (canceled)
